(19) United States
(12) Patent Application Publication
(10) Pub. No.: US 2012/0007414 A1
(43) Pub. Date: Jan. 12, 2012

(54) WHEEL COVER

(76) Inventor: Brian Posey, Boca Raton, FL (US)

(21) Appl. No.: 13/179,003

(22) Filed: Jul. 8, 2011

Related U.S. Application Data
(60) Provisional application No. 61/399,143, filed on Jul. 8, 2010.

(51) Int. Cl. B60B 7/06; B60B 7/00

(52) U.S. Cl. 301/37.102; 301/37.12

(57) ABSTRACT

A protective cover for automobile deep dish wheel rims is disk shaped and includes an annular groove protruding outwards from a back surface. A plurality of rubber gripping pads are included along the outward-facing surface of the annular groove for enhancing attachment of the cover to a wheel rim. A semi-circular groove in the annular groove is sized to accommodate the valve stem of the automobile tire. Handles protruding from a front surface of the cover enable gripping the protective cover when attaching and detaching the cover to a wheel rim. One or more annular shoulders on the disk shaped body of the cover to enhance rigidity of the cover. In a second preferred embodiment, the annular groove is fitted along its outer surface with a weather strip rather than rubber gripping pads.

This application claims the benefit of U.S. Provisional Patent Application Ser. No. 61/399,143 filed on Jul. 8, 2010.

### BACKGROUND OF THE INVENTION

1. Field of the Invention

The present invention relates to automobile wheels and rims and, more particularly, a protective cover for wheels and rims.

2. Discussion of the Related Art

Many automobile owners choose to customize the wheels of their vehicles (commonly referred to as having “after market custom wheels”) by installing custom rims. One of the most common ways to customize wheels is to install deep dish rims. Deep dish rims are expensive and their main purpose, beyond supporting the tires, is for aesthetic appeal. Therefore, for those users who choose to install custom deep dish rims, it is important that these rims remain clean and undamaged. Unfortunately, deep dish rims may often become damaged or dirtied while the automobile is being stored or cleaned. More specifically, during storage, dirt and dust accumulate along the rims, giving them a dirty appearance. Other forms of damage may occur, such as a tool being dropped and scratching the rim or a person walking near the vehicle with a large bag which rubs against the rim and scratches it. Additionally, during cleaning, chemicals which are harmful to the appearance of the rim are often used on other parts of the car (e.g. side doors, tires, etc.) which are close enough to the rims that these harmful chemicals will often spill or splash onto the rims, thereby causing some staining, discoloration, dirtying etc.

Accordingly, there remains a need for a protective cover for deep dish rims which may be easily attached and detached and which completely protects all exposed surfaces of the rims from any damage or dirtying during times of storage and/or cleaning.

### OBJECTS AND ADVANTAGES OF THE INVENTION

Considering the foregoing, it is a primary object of the present invention to provide a protective cover for rims which prevents the rims from being damaged or dirtied during periods of storage and/or cleaning.

It is a further object of the present invention to provide a protective cover for rims that can be easily attached and detached.

It is still a further object of the present invention to provide a protective cover for rims that protects all exposed surfaces of the rim while it is attached to the rim.

It is still a further object of the present invention to provide a protective cover for rims that is cheap and easy to manufacture.

It is still a further object of the present invention to provide a protective cover for rims that can be sold at an affordable price.

It is still a further object of the present invention to provide a protective cover for rims that may have any indicia (logos, custom artwork, etc.) printed on its outer surface.

It is still a further object of the present invention to provide a protective cover for rims that can be manufactured in any practical size to work in conjunction with any rim.

These and other objects and advantages of the present invention are more readily apparent with reference to the detailed description and accompanying drawings.

### SUMMARY OF THE INVENTION

The present invention discloses a protective cover for deep dish rims. The protective cover is disk shaped and is made of any suitable liquid-impermeable material, such as plastic or metal. An annular groove protrudes outwards from a back surface of the cover and includes a seal or a plurality of rubber gripping pads along its outward-facing surface for the purpose of snuggly attaching the cover to a rim and for sealing the plane of attachment from any liquids, dirt, or dust. A semi-circular groove in the annular groove is sized to accommodate the valve stem of the wheel. Two handles, protruding from a front surface of the cover, supply a means for gripping the protective cover when attaching and detaching the cover to a rim. In a preferred embodiment, a first center handle is located in the center of the cover and a second distal handle is located at a distance from the center of the cover. One or more annular shoulders are built into the cover to reduce the flexibility of the cover.

In a second preferred embodiment, the annular groove is fitted along its outer surface with a weather strip rather than rubber gripping pads. Whereas use of gripping pads allows for easier detachment of the wheel cover, a weather strip produces more friction between the annular groove and the inner-facing surface of the rim and is ideally used to seal the wheel rim from exposure to liquid chemicals that can damage the surface finish of the rim.

### BRIEF DESCRIPTION OF THE DRAWINGS

For a fuller understanding of the nature of the present invention, reference should be made to the following detailed description taken in conjunction with the accompanying drawings in which:

FIG. 1A is a perspective view of a first preferred embodiment illustrating a back side of the present invention, wherein gripping pads have been adhered to the outward-facing surface of the annular groove;

FIG. 1B is a perspective view of a first preferred embodiment illustrating a back side of the present invention, wherein gripping pads have been snap-locked into holes located on the outward-facing surface of the annular groove;

FIGS. 1C and 1D provide perspective views of gripping pads having varying thicknesses;

FIG. 2 is a top plan view of a first preferred embodiment illustrating the back side of the present invention;

FIG. 3 is a side elevational view of a second preferred embodiment of the present invention, wherein a weather strip is adhered to the outward-facing surface of the annular groove;

FIG. 4 is a perspective view of the wheel cover of the present invention being attached to a rim;

FIG. 5 is a perspective view of the wheel cover of the present invention being detached from a rim; and

FIG. 6 is a perspective view of the wheel cover of the present invention while it is attached to a rim on an automobile, wherein an elastomeric band wraps around the wheel cover and tire.

Like reference numerals refer to like parts throughout the several views of the drawings.

### DETAILED DESCRIPTION OF THE PREFERRED EMBODIMENTS

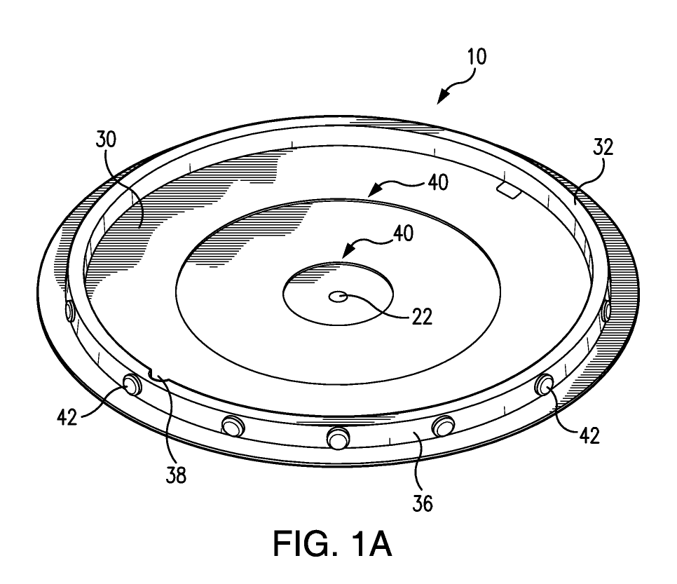

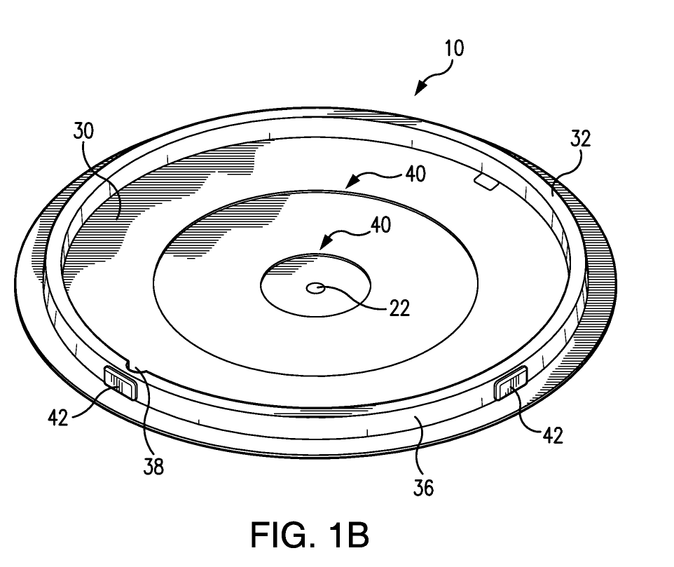

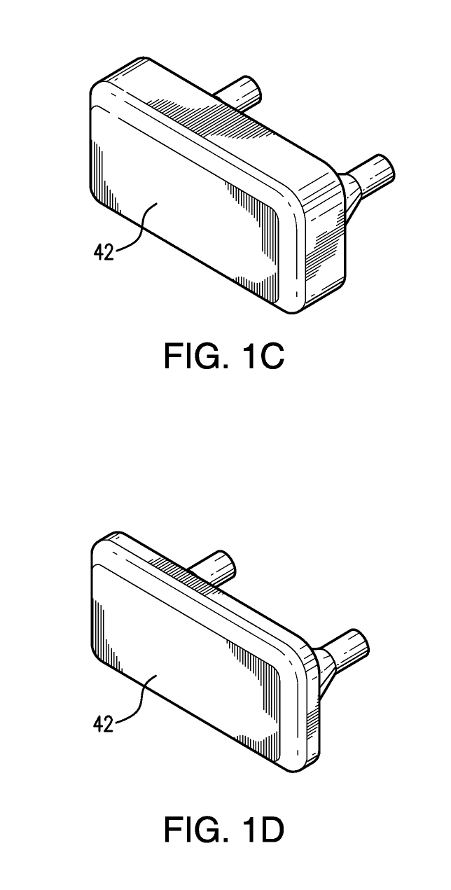

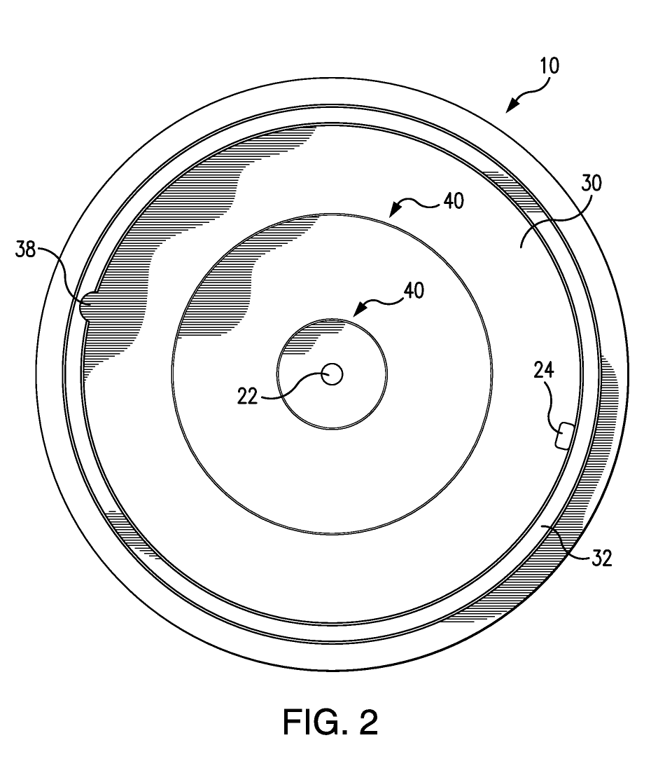

Referring initially to FIGS. 1A through 2, the first embodiment of the wheel cover of the present invention is shown and is generally indicated as 10. The wheel cover 10 is disk-shaped, having a front face 20 and a back face 30, and is made of any suitable liquid-impermeable material, such as plastic or metal.

An annular groove 32 extends outwardly from the back face of the wheel cover 10. In the first preferred embodiment, a plurality of gripping pads 42 are affixed to the outward-facing surface 36 of the annular groove 32 for sealed attachment to an automobile wheel rim 50, thereby protecting the wheel rim 50 from exposure to liquid, dirt, dust, and other contaminants. The annular groove 32 includes a semi-circular groove 38 that is sized and configured for accommodating a valve stem of a wheel to which it is attached.

The gripping pads 42 may be adhered to the outward-facing surface 36 of the annular groove 32, as shown in FIG. 1A, or, alternatively, the gripping pads 42 may be sized and configured for snap-lock engagement within a series of individual holes formed along the outward-facing surface 36 of the annular groove 32, as shown in FIG. 1B. As seen in FIGS. 1C and 1D, the gripping pads 42 may be manufactured having varying thicknesses for accommodating particular styles and models of rims 50 that, despite having the same outer diameter for use with the same corresponding tire size, have inner-facing surfaces of dissimilar diameters.

Two or more handles protrude from the front face 20 of the wheel cover 10, providing a means for attaching the cover 10 to the rim 50 and detaching the cover 10 from the rim 50. In a preferred embodiment, a first center handle 22 is located in the center of the cover 10 and a second distal handle 24 is located at a position between the center and outer perimeter of the cover 10. Additional handles may be included, as required or preferred.

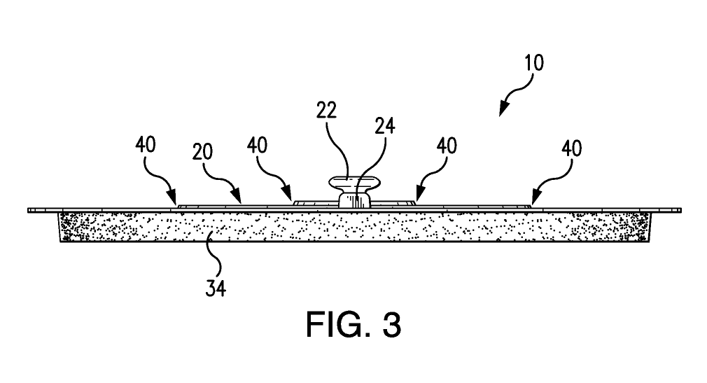

FIG. 3 illustrates a second preferred embodiment of the wheel cover 10, wherein the plurality of gripping pads 42 are replaced by a weather strip 34. As compared to the gripping pads 42, the weather strip 34 produces more friction between the annular groove 32 and the inner-facing surface of the rim 50, thereby providing a tighter seal. Therefore, this second preferred embodiment is particularly useful for situations in which the rims 50 will be protected by the cover 10 for an extended period of time. The weather strip 34 also provides the benefit of a complete, uninterrupted seal about the entire circumference between the cover 10 and the wheel rim 50. Conversely, the gripping pads 42 produce less friction when attached to the rim 50, thereby making both attachment and detachment relatively easier. Therefore, the first preferred embodiment utilizing the plurality of gripping pads 42 is particularly useful for situations when the cover 10 might be attached and detached relatively frequently (e.g. during the detailing of the automobile).

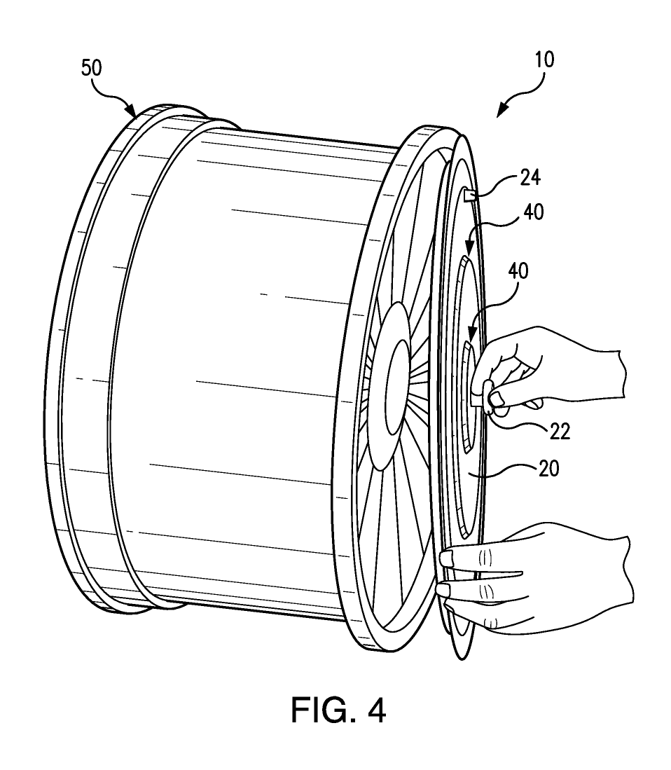

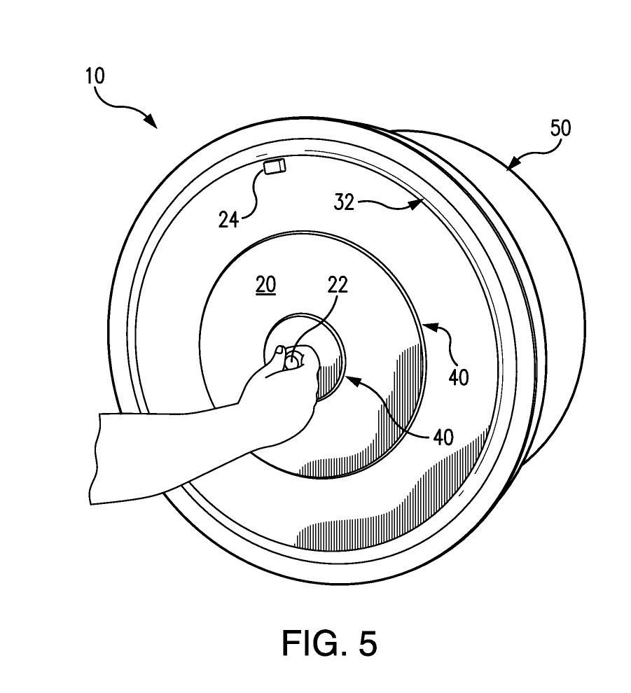

Referring to FIGS. 4 and 5, the process of attaching and detaching a wheel cover 10 to a rim 50 is provided. For attachment, the back face 30 of the cover 10 is inserted into the rim 50 such that the annular groove 32 engages the open portion of the rim 50. The plurality of gripping pads 42 on the outward-facing surface 36 of the annular groove 32 are formed of an elastomeric material, such as rubber, and are slightly oversized in relation to the inner-facing surface of the open portion of the rim 50, which produces enough friction to prevent detachment of the cover 10 unless pulled using the handles 22 and 24. The plurality of gripping pads 42 further provide a watertight seal between the cover 10 and the rim 50. In a preferred embodiment, one or more annular shoulders 40 are built into the wheel cover 10 to reduce the flexibility of the cover 10, thereby maintaining rigid attachment to the rim 50.

The wheel cover 10 effectively prevents a wide range of damaging substances, such as chemical solvents and silicones used during automobile cleaning, from coming into contact with the rim 50. The cover 10 further protects the rim 50 from the damaging effects of extended exposure to sun light.

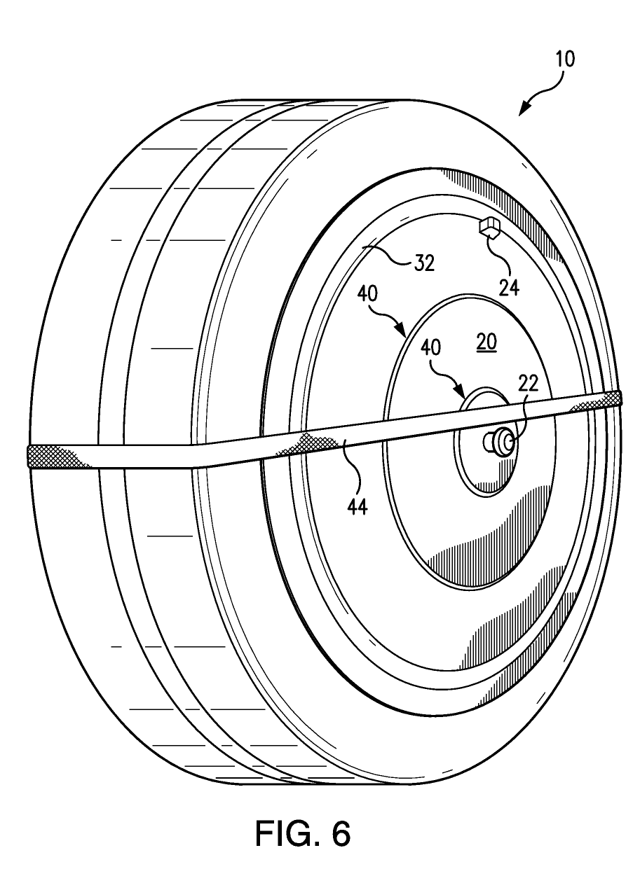

Referring to FIG. 6, an elastomeric band 44 may be used to wrap around said wheel cover 10 and the rim 50, thereby further preventing detachment of the wheel cover 10 from the rim 50. Use of an elastomeric band 44 is especially useful during storage of removed wheels, as handling of the removed wheels might otherwise cause the wheel cover 10 to be inadvertently detached from the rim 50. Use of this elastomeric band 44 is also useful when transporting an automobile on a vehicle transport truck.

While the present invention has been shown and described in accordance with several preferred and practical embodiments, it is recognized that departures from the instant disclosure are contemplated within the spirit and scope of the present invention which are not to be limited except as defined in the following claims as interpreted under the Doctrine of Equivalents.

What is claimed is:

1. A wheel cover for protecting an automobile wheel rim, said wheel cover comprising:
a disk;
an annular groove protruding from a back side of said disk, said annular groove being sized and configured for engaged attachment within said automobile wheel rim; and
a plurality of elastomeric gripping pads on an outward-facing surface of said annular groove, and said plurality of elastomeric gripping pads being structured and disposed for providing sealed engagement between said annular groove and said automobile wheel rim, wherein engaging said annular groove within said automobile wheel rim causes said plurality of elastomeric gripping pads to be pressed into sealed engagement with an inner-facing surface of said automobile wheel rim.

2. The wheel cover as recited in claim 1, wherein said plurality of elastomeric gripping pads are made of rubber.

3. The wheel cover as recited in claim 1, wherein said plurality of elastomeric gripping pads are adhered to the outer facing side of said annular groove.

4. The wheel cover as recited in claim 1, wherein each of said plurality of elastomeric gripping pads is sized and configured for snap-locked engagement with said annular groove.

5. The wheel cover as recited in claim 1, further comprising at least one handle protruding from a front side of said disk.

6. The wheel cover as recited in claim 5, wherein said at least one handle includes a first handle protruding from the center of the front side of said disk and a second handle protruding from the front side of said disk at a location between said first handle and an outer edge of said disk.

7. The wheel cover as recited in claim 1, further including a semi-circular groove formed in said disk for accommodating a valve stem of said automobile wheel rim when said annular groove is engaged with said automobile wheel rim.

8. The wheel cover as recited in claim 1, wherein said disk further comprises at least one annular shoulder located at a distance from the center of said disk, and said at least one annular shoulder being structured and disposed for enhancing rigidity of said disk.

9. The wheel cover as recited in claim 1, further comprising:
an elastomeric band sized and configured for wrapping around said wheel cover and said automobile wheel rim, and said elastomeric band being structured and disposed for maintaining engaged attachment of said wheel cover to said automobile wheel rim.

10. The wheel cover as recited in claim 1, wherein said sealed engagement between said annular groove and said automobile wheel rim is a watertight sealed engagement.

11. A wheel cover for protecting an automobile wheel rim, said wheel cover comprising:
a disk;
an annular groove protruding from a back side of said disk, said annular groove being sized and configured for engaged attachment within said automobile wheel rim; and
a weather strip adhered to an outward-facing surface of said annular groove, said weather strip being structured and disposed for providing sealed engagement between said annular groove and said automobile wheel rim, wherein engaging said annular groove within said automobile wheel rim causes said weather strip to be pressed into sealed engagement with an inner-facing surface of said automobile wheel rim.

12. The wheel cover as recited in claim 11, wherein said disk includes at least one handle protruding from a front side of said disk, said at least one handle being structured and disposed for gripping by a user when attaching and detaching said wheel cover to said automobile wheel rim.

13. The wheel cover as recited in claim 12, wherein said at least one handle includes a first handle protruding from the center of the front side of said disk and a second handle protruding from the front side of said disk at a location between said first handle and an outer edge of said disk.

14. The wheel cover as recited in claim 11, further comprising a semi-circular groove formed in said disk for accommodating a valve stem of said automobile wheel rim when said annular groove is engaged with said automobile wheel rim.

15. The wheel cover as recited in claim 11, wherein said disk further comprises at least one annular shoulder located at a distance from the center of said disk, and said at least one annular shoulder being structured and disposed for enhancing rigidity of said disk.

16. The wheel cover as recited in claim 11, wherein said wheel cover further comprises:
an elastomeric band sized and configured for wrapping around said wheel cover and said automobile wheel rim, and said elastomeric band being structured and disposed for maintaining engaged attachment of said wheel cover to said automobile wheel rim.

17. The wheel cover as recited in claim 11, wherein said sealed engagement between said annular groove and said automobile wheel rim is a watertight sealed engagement.
